(19) United States
(12) Patent Application Publication
(10) Pub. No.: US 2015/0237434 A1
(43) Pub. Date: Aug. 20, 2015

(54) ADAPTER FOR AN EARPIECE

(71) Applicant: MOTOROLA SOLUTIONS, INC., SCHAUMBURG, IL (US)

(72) Inventors: CHI T. TRAN, Weston (GB); RICHARD BUTLER, Davie (GB); Ketan Thakkar, SWINDON (GB)

(73) Assignee: MOTOROLA SOLUTIONS, INC., SCHAUMBURG, IL (US)

(21) Appl. No.: 14/184,843

(22) Filed: Feb. 20, 2014

(51) Int. Cl. H04R 1/10

(52) U.S. Cl. CPC H04R 1/105

(57) ABSTRACT

An adapter (150) for an earpiece (100) is provided to convert an on-ear device to an in-ear device. The adapter (150) is formed of a base (152) having clips (154) and an ear tip (156) extending therefrom. The base (150) clips onto the on-ear device (100) such that porting on the on-ear device is channeled through the ear tip (156) as an in-ear device.

### FIELD OF THE DISCLOSURE

The present disclosure relates generally to earpiece devices and more particularly to adapters for earpiece devices.

### BACKGROUND

Today's communication environment offers a wide variety of headphone, headset and earpiece devices. On-ear devices sit against the ear, near the ear canal. On-ear devices are typically desired from the hygiene and sharing purposes. In-ear devices, for example ear buds, fit snuggly into the user's ear. In-ear devices tend to provide improved isolation against external noise as well as increasing the audio level that is channeled to the ear. A user of an on-ear device might find himself in a situation where a reduction in external noise is desired. Thus, it would be desirable to have both on-ear and in-ear options.

### BRIEF DESCRIPTION OF THE FIGURES

The accompanying FIGURES, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an adapter for an earpiece in accordance with some embodiments.

Skilled artisans will appreciate that elements in the FIGURES are illustrated for simplicity and clarity and have not necessarily been drawn to scale. For example, the dimensions of some of the elements in the FIGURES may be exaggerated relative to other elements to help to improve understanding of embodiments of the present invention.

The apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Briefly, there is provided herein an adapter for an earpiece which converts an on-ear device to an in-ear device. The adapter formed in accordance with the embodiments comprises a base having clips and an ear tip extending therefrom. The base can be clipped onto the on-ear device such that porting on the on-ear device is channeled through the ear tip as an in-ear device. For the purposes of this application, the in-ear device is seated within the entrance of the ear canal. The on-ear device sits on or just slightly in front of the ear.

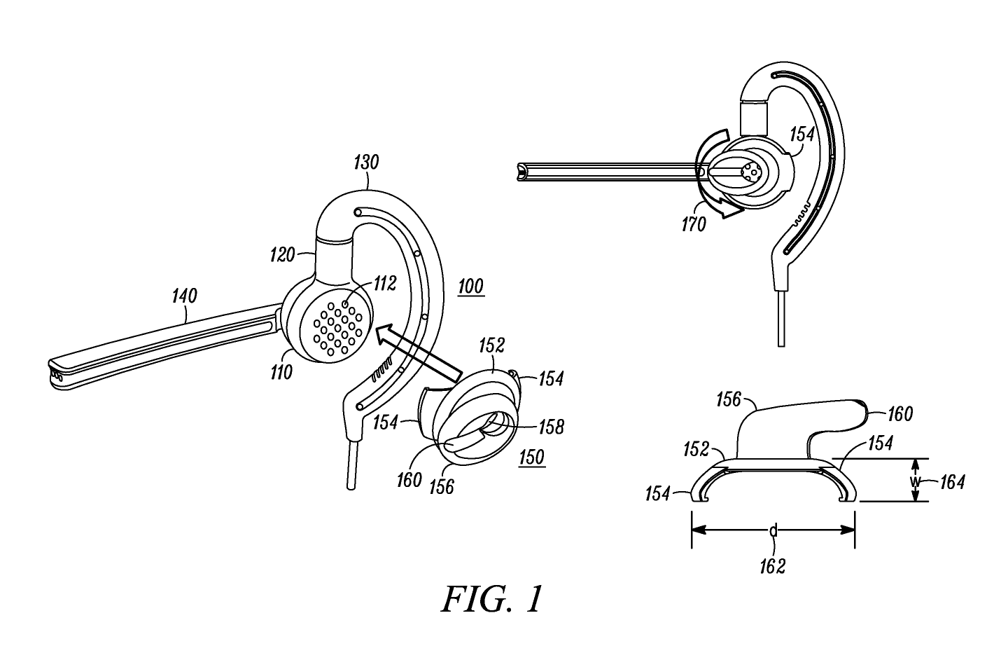

FIG. 1 is an adapter 150 for an earpiece 100 in accordance with some embodiments. Adapter 100 comprises an ear tip 156 and a base 152 coupled to the ear tip. In accordance with the embodiments, the base 152 comprises clips 154 extending therefrom for clipping on to the earpiece 100, wherein the clips provide a predetermined range of rotation 170 of the adapter 150 around the a speaker housing 110 of the earpiece 100. The adapter 150 can be used on different earpieces, an example of which is shown as on-ear earpiece 100. The adapter 150 thus advantageously converts an on-ear earpiece to an in-ear earpiece.

The on-ear earpiece 100 comprises an on-ear speaker housing 110 having inner and outer surfaces, the inner surface providing speaker porting 112. Depending on the application, the on-ear earpiece 100 may further comprise a shaft 120 extending from the speaker housing 110, an ear loop 130 coupled to the shaft, and if desired, a microphone, such as a boom microphone 140, shown here as coupled to the speaker housing. The ear loop 130 fits over the ear such that the speaker housing 110 sits just on or next to the ear, but not in the ear.

The rotation of the adapter 150 can be limited by a hard stop on the speaker housing 110. In the embodiment shown in FIG. 1, the shaft 120 operates as the hard stop for controlling the rotation of the of the adapter's base 152 between the clips 154.

The adapter's base 152 is formed of a cup-like shape which couples, via the clips 154, to the speaker housing 110 which has a corresponding circular shape. The base and clips are formed as a unitary piece part. An insert molding process can be used to form the adapter 150 such that the base and clips are substantially rigid while the ear tip is malleable. Since the ear tip is malleable ear tip it is easily insertable into a user's ear canal to provide an occluded surrounding with a channel 160 for sound. The malleable ear tip 156 is formed of an elliptical shape having an aperture 158 which aligns with the ports 112 of the earpiece housing 110. The elliptical shaping provides shoe-horn like sides within which a trench 160 is integrally molded to channel sound. The earpiece 110 sits on the ear, and the base coupled to the earpiece is rotatable to adjust positioning of the ear tip 156 within a user's ear canal. The ear tip 156 rotates as the base 152 is rotated about the speaker housing 110.

The sizing of the adapter is dependent on the size of the speaker housing 110, however the sizing is preferably selected to ensure an on-ear placement. The on-ear placement helps maintain a hygienic environment. For example, the base 152 of the adapter 150 may have a diameter 162 of 22 mm and a width 164 provided by the clips of 18 mm. The adapter 150 may be formed of plastic material or other sufficiently rigid or stiff material, and the ear tip may be formed of silicone rubber material or other malleable types of material. The base 152 provides sufficient stiffness such that the adapter 150 is removable to and from the speaker housing 110 via the clips 154. The clips 154 also prevent inadvertent removal of the adapter 150 from the speaker housing 110 when the earpiece 100 is removed from the ear.

Accordingly, there has been provided an adapter for an earpiece which advantageously converts an on-ear earpiece to an in-ear earpiece. The adapter 150 provides for customized positioning of the ear tip 156 due to the fact that the adapter 150 can be rotated while the speaker housing 110 is located on the user's ear. The user's fingers remain external to the ear canal thereby helping to maintain a clean, hygienic environment during adjustment. The adapter 150 is mountable to left and/or right earpieces.

In the foregoing specification, specific embodiments have been described. However, one of ordinary skill in the art appreciates that various modifications and changes can be made without departing from the scope of the invention as set forth in the claims below. Accordingly, the specification and FIGURES are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. An adapter for an earpiece, comprising:
an ear tip; and
a base coupled to the ear tip, the base having clips extending therefrom for clipping on to a speaker housing of the earpiece, the clips providing a predetermined range of rotation of the adapter around the speaker housing; and
wherein the speaker housing sits on an ear, and the base is rotatable to adjust positioning of the ear tip within an ear canal for customized positioning of the ear tip.

2. The adapter of claim 1, wherein the adapter converts an on-ear earpiece to an in-ear earpiece.

3. The adapter of claim 1, wherein the base is a rigid base.

4. The adapter of claim 1, wherein the base and clips are formed as a unitary piece part.

5. The adapter of claim 1, wherein the base is circular for coupling to a circular speaker housing.

6. The adapter of claim 1, wherein the ear tip is a malleable ear tip which is insertable into a user's ear canal.

7. The adapter of claim 1, wherein the ear tip comprises an integrally molded trench for channeling audio.

8. The adapter of claim 1, wherein the ear tip rotates as the base is rotated.

9. (canceled)

10. The adapter of claim 1, wherein the base of the adapter has an aperture within which to retain the ear tip, and the ear tip has an opening to align with audio porting of the speaker housing.

11. The adapter of claim 1, wherein the ear tip is insert molded to the base.

12. The adapter of claim 1, wherein the base of the adapter has a diameter of 22 mm and a width provided by the clips of 18 mm.

13. The adapter of claim 1, wherein the adapter is removable to and from the speaker housing via the clips.

14. The adapter of claim 1, wherein the base is formed of plastic material, and the ear tip is formed of silicone rubber material.

15. The adapter of claim 1, wherein the speaker housing comprises a hard stop for limiting a range of rotation between the clips.

16. The adapter of claim 15, wherein the hard stop is provided by a shaft on the speaker housing.

17. (canceled)

18. The adapter of claim 1, wherein the adapter is mountable to left and/or right earpieces.

19. The adapter of claim 6, wherein the malleable ear tip is formed of an elliptical shape having an aperture which aligns with the ports of the speaker housing.
